(19) United States
(12) Patent Application Publication
(10) Pub. No.: US 2023/0025005 A1
(43) Pub. Date: Jan. 26, 2023

(54) APPARATUS AND METHOD OF WIRELESS COMMUNICATION

(71) Applicant: GUANGDONG OPPO MOBILE TELECOMMUNICATIONS CORP., LTD., Dongguan (CN)

(72) Inventor: Li GUO, Allen, TX (US)

(73) Assignee: GUANGDONG OPPO MOBILE TELECOMMUNICATIONS CORP., LTD., Dongguan (CN)

(21) Appl. No.: 17/948,765

(22) Filed: Sep. 20, 2022

Related U.S. Application Data
(63) Continuation of application No. PCT/CN2021/081136, filed on Mar. 16, 2021.

(51) Int. Cl. H04W 72/12; H04L 1/08

(52) U.S. Cl. CPC H04W 72/1268; H04L 1/08; H04W 72/1289

(57) ABSTRACT

An apparatus and a method of wireless communication are provided. The method by a user equipment (UE) includes being scheduled with a physical uplink shared channel (PUSCH) with one or more repetition transmissions and being indicated with transmission configurations for the PUSCH with one or more repetition transmissions, wherein for the PUSCH with one or more repetition transmissions, an indicated transmission configuration is applied on each PUSCH transmission occasion, and a redundancy version is applied on at least one PUSCH transmission occasion associated with the transmission configurations. This can solve issues in the prior art, utilize multi-transmission/reception point (TRP) reception, improve uplink reliability, provide a good communication performance, and/or provide high reliability.

### CROSS REFERENCE

This application is a continuation of an International Application No. PCT/CN2021/081136, entitled “APPARATUS AND METHOD OF WIRELESS COMMUNICATION”, filed on Mar. 16, 2021, which claims the benefit of priority to U.S. Provisional Application No. 63/001,661, filed Mar. 30, 2020, both of which are incorporated herein by reference in their entireties.

### BACKGROUND OF DISCLOSURE

### 1. Field of the Disclosure

The present disclosure relates to the field of communication systems, and more particularly, to an apparatus and a method of wireless communication, which can provide a good communication performance and/or high reliability.

### 2. Description of the Related Art

New radio (NR) system introduces a multi-transmission/reception point (TRP) based non-coherent joint transmission. Multiple TRPs are connected through backhaul link for coordination. The backhaul link can be ideal or non-ideal. In the case of ideal backhaul, the TRPs can exchange dynamic physical downlink shared channel (PDSCH) scheduling information with short latency and thus different TRPs can coordinate a PDSCH transmission per PDSCH transmission. While, in non-ideal backhaul case, the information exchange between TRPs has large latency and thus the coordination between TRPs can only be semi-static or static.

In current methods, physical uplink shared channel (PUSCH) can only be sent with one transmission configuration that include a sounding reference signal (SRS) resource for port indication and uplink power control parameters. The SRS resource for port indication also implicitly indicate a spatial setting for PUSCH transmission. Due to that design, the UE can only transmit the PUSCH to one TRP. In a multi-TRP system, to increase reliability of PUSCH transmission, the UE can send the same uplink transport block to both TRPs. The current method is not able to support that. The consequence is that the current method cannot utilize diversity of multi-TRP reception to improve uplink reliability.

Therefore, there is a need for an apparatus (such as a user equipment (UE) and/or a base station) and a method of wireless communication, which can solve issues in the prior art, utilize multi-transmission/reception point (TRP) reception, improve uplink reliability, provide a good communication performance, and/or provide high reliability.

### SUMMARY

An object of the present disclosure is to propose an apparatus (such as a user equipment (UE) and/or a base station) and a method of wireless communication, which can solve issues in the prior art, utilize multi-transmission/reception point (TRP) reception, improve uplink reliability, provide a good communication performance, and/or provide high reliability.

In a first aspect of the present disclosure, a method of wireless communication by a user equipment (UE) comprises being scheduled with a physical uplink shared channel (PUSCH) with one or more repetition transmissions and being indicated with transmission configurations for the PUSCH with one or more repetition transmissions, wherein for the PUSCH with one or more repetition transmissions, an indicated transmission configuration is applied on each PUSCH transmission occasion, and a redundancy version is applied on at least one PUSCH transmission occasion associated with the transmission configurations.

In a second aspect of the present disclosure, a method of wireless communication by a base station comprises scheduling, to a user equipment (UE), a physical uplink shared channel (PUSCH) with one or more repetition transmissions and indicating, to the UE, transmission configurations for the PUSCH with one or more repetition transmissions, wherein for the PUSCH with one or more repetition transmissions, an indicated transmission configuration is applied on each PUSCH transmission occasion, and a redundancy version is applied on at least one PUSCH transmission occasion associated with the transmission configurations.

In a third aspect of the present disclosure, a user equipment comprises a memory, a transceiver, and a processor coupled to the memory and the transceiver. The processor is configured to be scheduled with a physical uplink shared channel (PUSCH) with one or more repetition transmissions. The processor is configured to be indicated with transmission configurations for the PUSCH with one or more repetition transmissions. For the PUSCH with one or more repetition transmissions, an indicated transmission configuration is applied on each PUSCH transmission occasion, and a redundancy version is applied on at least one PUSCH transmission occasion associated with the transmission configurations.

In a fourth aspect of the present disclosure, a base station comprises a memory, a transceiver, and a processor coupled to the memory and the transceiver. The processor is configured to schedule, to a user equipment (UE), a physical uplink shared channel (PUSCH) with one or more repetition transmissions. The processor is configured to indicate, to the UE, transmission configurations for the PUSCH with one or more repetition transmissions. For the PUSCH with one or more repetition transmissions, an indicated transmission configuration is applied on each PUSCH transmission occasion, and a redundancy version is applied on at least one PUSCH transmission occasion associated with the transmission configurations.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram illustrating that example of multi-transmission/reception point (TRP) transmission according to an embodiment of the present disclosure.

FIG. 1B is a schematic diagram illustrating that example of multi-transmission/reception point (TRP) transmission according to an embodiment of the present disclosure.

FIG. 2 is a block diagram of one or more user equipments (UEs) and a base station (e.g., gNB or eNB) of communication in a communication network system according to an embodiment of the present disclosure.

FIG. 3 is a flowchart illustrating a method of wireless communication by a user equipment (UE) according to an embodiment of the present disclosure.

FIG. 4 is a flowchart illustrating a method of wireless communication by a base station according to an embodiment of the present disclosure.

FIG. 5 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In non-coherent joint transmission, different transmission/reception points (TRPs) use different physical downlink control channels (PDCCHs) to schedule physical downlink sharing channel (PDSCH) transmission independently. Each TRP can send one downlink control information (DCI) to schedule one PDSCH transmission. PDSCHs from different TRPs can be scheduled in the same slot or different slots. Two different PDSCH transmissions from different TRPs can be fully overlapped or partially overlapped in PDSCH resource allocation. To support multi-TRP based non-coherent joint transmission, a user equipment (UE) is requested to receive PDCCH from multiple TRPs and then receive PDSCH sent from multiple TRPs. For each PDSCH transmission, the UE can feedback a hybrid automatic repeat request-acknowledge (HARQ-ACK) information to a network. In multi-TRP transmission, the UE can feedback the HARQ-ACK information for each PDSCH transmission to the TRP transmitting the PDSCH. The UE can also feedback the HARQ-ACK information for a PDSCH transmission sent from any TRP to one particular TRP.

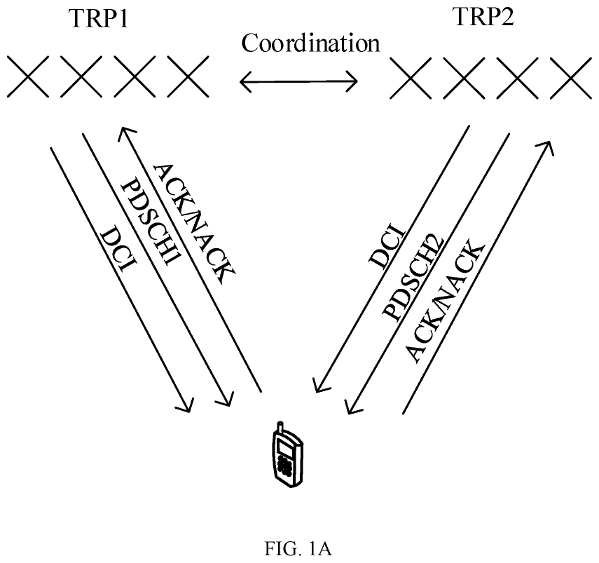

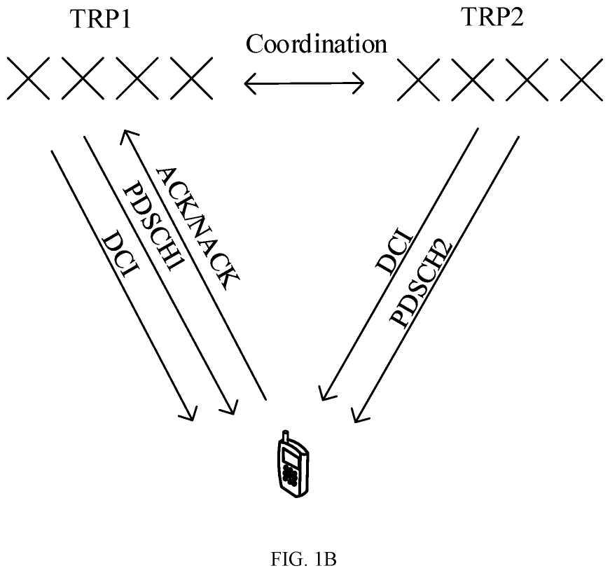

An example of multi-TRP based non-coherent joint transmission is illustrated in FIG. 1A. A UE receives a PDSCH based on non-coherent joint transmission from two TRPs: TRP1 and TRP2. As illustrated in FIG. 1A, the TRP1 sends one DCI to schedule a transmission of PDSCH 1 to the UE and the TRP2 sends one DCI to schedule a transmission of PDSCH 2 to the UE. At the UE side, the UE receives and decodes DCI from both TRPs. Based on the DCI from the TRP1, the UE receives and decodes the PDSCH 1 and based on the DCI from the TRP2, the UE receives and decodes the PDSCH 2. In the example illustrated in FIG. 1A, the UE reports HARQ-ACK for PDSCH 1 and PDSCH2 to the TRP1 and the TRP 2, respectively. The TRP1 and the TRP 2 use different control resource sets (CORESETs) and search spaces to transmit DCI scheduling PDSCH transmission to the UE. Therefore, the network can configure multiple CORESETs and search spaces. Each TRP can be associated with one or more CORESETs and also the related search spaces. With such configuration, the TRP would use the associated CORESET to transmit DCI to schedule a PDSCH transmission to the UE. The UE can be requested to decode DCI in CORESETs associated with either TRP to obtain PDSCH scheduling information.

Another example of multi-TRP transmission is illustrated in FIG. 1B. A UE receives PDSCH based on non-coherent joint transmission from two TRPs: TRP1 and TRP2. As illustrated in FIG. 1B, the TRP1 sends one DCI to schedule a transmission of PDSCH 1 to the UE and the TRP2 sends one DCI to schedule the transmission of PDSCH 2 to the UE. At the UE side, the UE receives and decodes DCI from both TRPs. Based on the DCI from the TRP1, the UE receives and decodes the PDSCH 1 and based on the DCI from the TRP2, the UE receives and decodes the PDSCH 2. In the example illustrated in FIG. 1B, the UE reports HARQ-ACK for both PDSCH 1 and PDSCH2 to the TRP, which is different from the HARQ-ACK reporting in the example illustrated in FIG. 1A. The example illustrated in FIG. 1B needs ideal backhaul between the TRP 1 and the TRP 2, while the example illustrated in FIG. 1A can be deployed in the scenarios that the backhaul between the TRP 1 and the TRP 2 is ideal or non-ideal.

In new radio/5th generation (NR/5G) systems, a higher layer parameter CORSETPoolIndex is used to differentiate whether multi-TRP transmission is supported in one serving cell or not. In one serving cell, if multi-TRP transmission is supported, CORESETs in that serving cell would be configured with one of two different values for the higher layer parameter CORESETPoolIndex. In details, in one bandwidth part (BWP) of the serving cell, if the UE is provided with higher layer parameter CORESETPoolIndex with a value of 0 or not provided with higher layer parameter for some CORESETs and is provided with higher layer parameter CORESETPoolIndex with a value of 1 for other CORESET(s), then multi-TRP transmission is supported for that UE in the BWP of the serving cell.

In one active BWP of a serving cell, the UE can be configured with one of the following HARQ-ACK feedback modes: a joint HARQ-ACK feedback mode and a separate HARQ-ACK feedback mode. In the joint HARQ-ACK feedback mode, the HARQ-ACK bits for PDSCHs from all the TRPs are multiplexed in one same HARQ codebook and then the UE reports that HARQ-ACK codebook in one physical uplink control channel (PUCCH) or physical uplink shared channel (PUSCH) to the system. In contrast, in the separate HARQ-ACK feedback mode, the UE generates HARQ-ACK codebook for the PDSCHs of each TRP separately and then reports each HARQ-ACK codebook separately in different PUCCH transmissions or PUSCH transmissions. In separate HARQ-ACK transmission, the UE would assume the PUCCHs carrying HARQ-ACK bits for different TRPs are not overlapped in time domain.

Current 5G specification supports two methods of PUSCH repetition transmission: slot-based repetition and mini-slot repetition. In slot-based repetition (i.e., Type A repetition), the UE is indicated with a repetition number K for the PUSCH transmission and the same symbol allocation is applied across K consecutive slots and the PUSCH is limited to a single transmission layer. The UE may repeat the transport block (TB) across K consecutive slots applying the same symbol allocation in each slot.

In mini-slot based repetition (i.e., type B repetition), the UE is indicated with a repetition number of K for the PUSCH transmission and the UE transmits the K PUSCH repetition in consecutive symbols. The UE determines the symbol location and slot location for each nominal PUSCH repetition of type B as follows. For PUSCH repetition type B, the number of nominal repetitions is given by numberofrepetitions. For the n-th nominal repetition, n=0, . . . , numberofrepetitions−1. The slot where the nominal repetition starts is given by

$${K}_{s} + ⌊ \frac{S + n \cdot L}{{N}_{symb}^{slot}} ⌋ ,$$

and the starting symbol relative to the start of the slot is given by mod(S+n·L,N_{symb}^{slot}). The slot where the nominal repetition ends is given by

$${K}_{s} + ⌊ \frac{S + ( n + 1 ) \cdot L - 1}{{N}_{symb}^{slot}} ⌋ ,$$

and the ending symbol relative to the start of the slot is given by mod(S+(n+1)·L−1N_{symb}^{slot}). Here Kₛ is the slot where the PUSCH transmission starts, and N_{symb}^{slot} is the number of symbols per slot.

For PUSCH repetition Type B, the UE may first determine invalid symbols for PUSCH repetition type B according some conditions. For PUSCH repetition Type B, after determining the invalid symbol(s) for PUSCH repetition type B transmission for each of the K nominal repetitions, the remaining symbols are considered as potentially valid symbols for PUSCH repetition Type B transmission. If the number of potentially valid symbols for PUSCH repetition type B transmission is greater than zero for a nominal repetition, the nominal repetition consists of one or more actual repetitions, where each actual repetition consists of a consecutive set of potentially valid symbols that can be used for PUSCH repetition Type B transmission within a slot. An actual repetition is omitted according to the conditions as defined by the slot format determination. The redundancy version to be applied on the nth actual repetition (with the counting including the actual repetitions that are omitted) is determined according to the following table.

TABLE

| rv_{id} indicated | rv_{id} to be applied to n^{th} transmission occasion | | | |
|---|---|---|---|---|
| by the | (repetition Type A) or | | | |
| DCI scheduling | n^{th} actual repetition (repetition Type B) | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

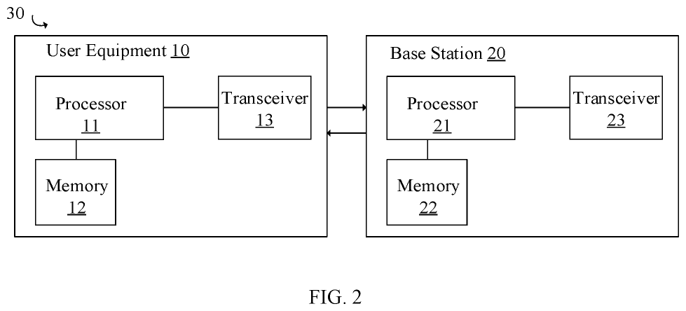

FIG. 2 illustrates that, in some embodiments, one or more user equipments (UEs) 10 and a base station (e.g., gNB or eNB) 20 for transmission adjustment in a communication network system 30 according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to be scheduled with a physical uplink shared channel (PUSCH) with one or more repetition transmissions. The processor 11 is configured to be indicated with transmission configurations for the PUSCH with one or more repetition transmissions. For the PUSCH with one or more repetition transmissions, an indicated transmission configuration is applied on each PUSCH transmission occasion, and a redundancy version is applied on at least one PUSCH transmission occasion associated with the transmission configurations. This can solve issues in the prior art, utilize multi-transmission/reception point (TRP) reception, improve uplink reliability, provide a good communication performance, and/or provide high reliability.

In some embodiments, the processor 21 is configured to schedule, to the UE 10, a physical uplink shared channel (PUSCH) with one or more repetition transmissions. The processor 21 is configured to indicate, to the UE 10, transmission configurations for the PUSCH with one or more repetition transmissions. For the PUSCH with one or more repetition transmissions, an indicated transmission configuration is applied on each PUSCH transmission occasion, and a redundancy version is applied on at least one PUSCH transmission occasion associated with the transmission configurations. This can solve issues in the prior art, utilize multi-transmission/reception point (TRP) reception, improve uplink reliability, provide a good communication performance, and/or provide high reliability.

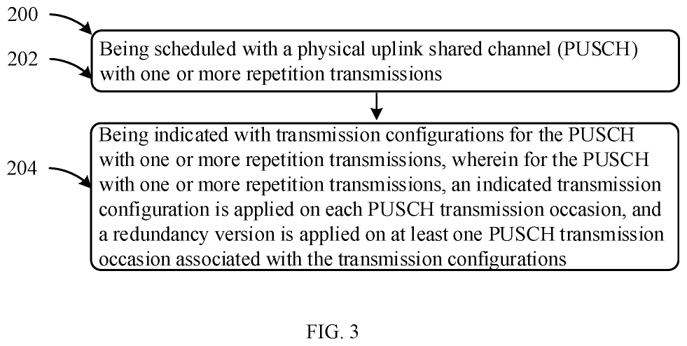

FIG. 3 illustrates a method 200 of wireless communication by a user equipment (UE) 10 according to an embodiment of the present disclosure. In some embodiments, the method 200 includes: a block 202, being scheduled with a physical uplink shared channel (PUSCH) with one or more repetition transmissions, and a block 204, being indicated with transmission configurations for the PUSCH with one or more repetition transmissions, wherein for the PUSCH with one or more repetition transmissions, an indicated transmission configuration is applied on each PUSCH transmission occasion, and a redundancy version is applied on at least one PUSCH transmission occasion associated with the transmission configurations. This can solve issues in the prior art, utilize multi-transmission/reception point (TRP) reception, improve uplink reliability, provide a good communication performance, and/or provide high reliability.

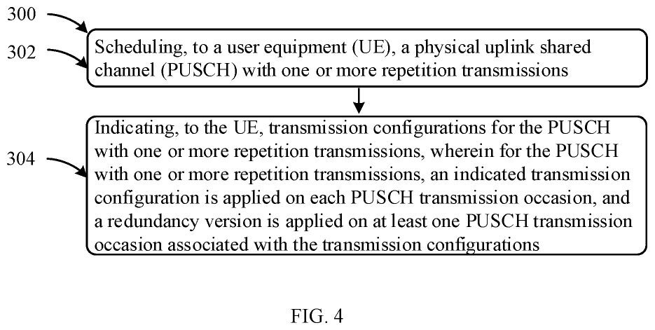

FIG. 4 illustrates a method 300 of wireless communication by a base station 20 according to an embodiment of the present disclosure. In some embodiments, the method 300 includes: a block 302, scheduling, to a user equipment (UE), a physical uplink shared channel (PUSCH) with one or more repetition transmissions, and a block 304, indicating, to the UE, transmission configurations for the PUSCH with one or more repetition transmissions, wherein for the PUSCH with one or more repetition transmissions, an indicated transmission configuration is applied on each PUSCH transmission occasion, and a redundancy version is applied on at least one PUSCH transmission occasion associated with the transmission configurations. This can solve issues in the prior art, utilize multi-transmission/reception point (TRP) reception, improve uplink reliability, provide a good communication performance, and/or provide high reliability.

In some embodiments, the transmission configurations comprise transmission configuration indicator (TCI) states and/or higher layer parameters configured to provide a mapping between a sounding reference signal (SRS) resource indicator (SRI) and PUSCH power control parameters. In some embodiments, each of the TCI states comprises a transmission mode of the PUSCH, one or more SRS resources for port indication, a spatial relation configuration, and/or one or more uplink power control parameters. In some embodiments, the higher layer parameters comprise SRI-PUSCH-PowerControl parameters, and each of the SRI-PUSCH-PowerControl parameters comprises a sri-PUSCH-PowerControlId parameter, a sri-PUSCH-PathlossReferenceRS-Id parameter, a sri-P0-PUSCH-AlphaSetId parameter, and/or a sri-PUSCH-ClosedLoopIndex parameter. In some embodiments, the UE is requested to apply an indicated transmission configuration on one or more PUSCH repetition transmissions.

In some embodiments, the PUSCH with one or more repetition transmissions comprise a PUSCH type A repetition and a PUSCH type B repetition, and the TCI states comprises a first TCI state and a second TCI state. In some embodiments, for the PUSCH type A repetition, an indicated transmission configuration is applied on each PUSCH transmission. In some embodiments, for the PUSCH type B repetition, an indicated transmission configuration is applied on each PUSCH nominal repetition or each PUSCH actual repetition. In some embodiments, for the PUSCH type A repetition, the redundancy version is applied on PUSCH transmission occasions associated with the first TCI state and the second TCI state respectively. In some embodiments, for the PUSCH type B repetition, the redundancy version is applied on PUSCH nominal repetitions or PUSCH actual repetitions associated with the first TCI state and the second TCI state respectively.

In some embodiments, for the PUSCH type B repetition, the UE is provided with a number of symbols between two PUSCH transmissions. In some embodiments, for the PUSCH type B repetition, the UE is provided with the number of symbols between two PUSCH transmissions via a first higher layer parameter. In some embodiments, the number of symbols is greater than 0 when the two PUSCH transmissions are associated with different TCI states. In some embodiments, the number of symbols is zero when the two PUSCH transmissions are associated with the same TCI state. In some embodiments, the UE is configured to apply the number of symbols on PUSCH nominal repetitions or PUSCH actual repetitions. In some embodiments, the UE is configured to determine a location of the number of symbols for each PUSCH nominal repetition or each PUSCH actual repetition. In some embodiments, the UE applies the number of symbols between two adjacent PUSCH nominal repetitions or two adjacent PUSCH actual repetitions when the two adjacent PUSCH nominal repetitions or the two adjacent PUSCH actual repetitions are associated with different TCI states.

In some embodiments, the UE is scheduled with the PUSCH with one or more repetition transmissions through downlink control information (DCI). In some embodiments, the DCI comprises a DCI format 0_1 or a DCI format 0_2. In some embodiments, one or more TCI states or one or more higher layer parameters are mapped to one or more codepoints of a DCI field in the DCI. In some embodiments, the DCI indicates a first SRI DCI field and a second SRI DCI field, the first SRI DCI field indicates one or more SRS resources and one SRI-PUSCH-PowerControl parameter, and/or the second SRI DCI field indicates one or more SRS resources and one SRI-PUSCH-PowerControl parameter.

In some embodiments, a mapping pattern of applying an indicated transmission configuration is performed on each PUSCH transmission occasion. In some embodiments, the mapping pattern is configured by radio resource control (RRC). In some embodiments, the mapping pattern is mapped to one or more codepoints of a DCI field of the DCI by a medium access control (MAC) control element (CE). In some embodiments, an SRI bit field of the DCI indicates one or two combinations of SRS resources and uplink power control parameters. In some embodiments, for the PUSCH type A repetition and/or the PUSCH type B repetition, one or more indicated combinations of SRS resources and uplink power control parameters are applied on each PUSCH transmission occasion. In some embodiments, a mapping between an SRI codepoint to one or more indicated combinations of SRS resources and uplink power control parameters is configured in an RRC. In some embodiments, a mapping between an SRI codepoint to one or more indicated combinations of SRS resources and uplink power control parameters is activated by a MAC CE. In some embodiments, bit fields in the DCI indicate indicated combinations of SRS resources and uplink power control parameters for the PUSCH type A repetition and/or the PUSCH type B repetition.

In one embodiment, a UE can be scheduled with a PUSCH with repetition transmission through DCI format 0_1 or 0_2. For the PUSCH with repetition transmission, the UE can be indicated with two (two is used an example here, it can be any number >1) transmission configurations, each of which can contains SRS resource(s) for PUSCH port indication, spatial setting, and/or uplink power control parameter, for PUSCH with repetition transmission. The UE can be requested to apply the indicated transmission configuration on each PUSCH transmission among those repetition transmissions according to a predefined or configured application pattern. In one example, the UE is scheduled with a PUSCH transmission with 4 repetitions and the UE is indicated with two transmission configurations: a first transmission configuration and a second transmission configuration. The UE can be requested to apply one of the first transmission configuration and the second transmission configuration on each PUSCH repetition transmission. For example, the UE may apply the first transmission configuration on the 1^{st} and 3^{rd} PUSCH repetition transmissions and apply the second transmission configuration on the 2^{nd} and 4^{th} PUSCH repetition transmissions.

In an exemplary method, a UE can be configured with a list of M UL TCI states for PUSCH transmission. Each UL TCI state can contain one or more of the following information for PUSCH transmission:

Transmission mode of a PUSCH: for example, it can be codebook-based PUSCH transmission or non-codebook-based PUSCH transmission.

One or more SRS resources for port indication.

Spatial relation configuration to provide the configuration information for the UE to derive spatial domain transmission filter, which can be provided with a SS/PBCH block index, CSI-RS resource ID or SRS resource ID.

Uplink power control parameters including p0, alpha, pathloss RS, and closedloop index.

The UE can receive a MAC CE command that activate up to, for example, 8 combinations of one or two UL TCI states for PUSCH transmission and each combination of one or two UL TCI states is mapped to one codepoint of a first DCI field in the DCI format scheduling PUSCH transmission for example DCI format 0_1 or 0_2. For a PUSCH transmission with Type A or Type B repetition scheduled by a DCI format, for example DCI format 0_1 or 0_2, the first DCI field in the DCI format can indicate two UL TCI states for the PUSCH transmission, the UE may apply those two indicated UL TCI states on each PUSCH transmission according some predefined rule or configured pattern. Those two UL TCI states indicated by the first DCI field are called the first TCI state and the second TCI state here.

In one example, if the PUSCH repetition is Type A, the same symbol allocation for PUSCH is applied across K constructive slots, where the K is the number of repetitions indicated to the UE. The UE may repeat the TB across the K consecutive slots applying the same symbol allocation in each slot. The UE can be requested to apply the first UL TCI state and the second TCI state on PUSCH transmission occasions as configured. For all PUSCH transmission occasions of the TB associated with the first UL TCI state, the redundancy version to be applied is derived according to Table 1A, where n is counted only considering PUSCH transmission occasions associated with the first TCI state. The redundancy version for PUSCH transmission occasions associated with the second TCI state is derived according to Table 1B, where additional shifting operation for each redundancy version rvₛ can be configured by a higher layer parameter and n is counted only considering PUSCH transmission occasions associated with the second UL TCI state.

TABLE 1A
Redundancy version for PUSCH transmission of the first TCI state

| rv_{id} indicated | rv_{id} to be applied to n^{th} transmission occasion | | | |
|---|---|---|---|---|
| by the | (repetition Type A) or | | | |
| DCI scheduling | n^{th} actual repetition (repetition Type B) | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 1B
Applied redundancy version for PUSCH of the second TCI state

| rv_{id} indicated | | | | |
|---|---|---|---|---|
| by the | rv_{id} to be applied to n^{th} transmission occasion | | | |
| DCI scheduling | (repetition type A) with second TCI state | | | |
| the PUSCH | n mod 4 = 0 | n mod 4 = 1 | n mod 4 = 2 | n mod 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

In one example, if a PUSCH repetition is Type B, the UE is indicated with the starting symbol S, length L and the number of nominal repetitions numberofrepetitions. The UE may first determine the slot and symbol location for each of the nominal repetition. The UE determines invalid symbol(s) and then determine actual PUSCH repetition(s).

In a first exemplary alternative, the UE can be requested to map the first UL TCI state and the second TCI state to each nominal repetition according to some configured pattern. For all nominal repetitions associated with the first UL TCI state, the redundancy version to be applied is derived according to Table 1A, where n is counted only considering PUSCH nominal repetitions associated with the first TCI state. The redundancy version for PUSCH nominal repetitions associated with the second TCI state is derived according to Table 1B, where additional shifting operation for each redundancy version rvₛ can be configured by a higher layer parameter and n is counted only considering PUSCH nominal repetitions associated with the second UL TCI state.

In a second exemplary alternative, the UE can be requested to map the first UL TCI state and the second TCI state to each actual repetition according to some configured pattern. For all actual repetitions associated with the first UL TCI state, the redundancy version to be applied is derived according to Table 2A, where n is counted only considering PUSCH actual repetitions associated with the first TCI state. The redundancy version for PUSCH actual repetitions associated with the second TCI state is derived according to Table 2B, where additional shifting operation for each redundancy version rvₛ can be configured by a higher layer parameter and n is counted only considering PUSCH actual repetitions associated with the second UL TCI state.

TABLE 2A
Redundancy version for PUSCH actual repetitions of the first TCI state

| | rv_{id} to be applied to n^{th} actual repetition | | | |
|---|---|---|---|---|
| rv_{id} indicated by the | (repetition Type B) | | | |
| DCI scheduling the | n | n | n | n |
| PUSCH | mod 4 = 0 | mod 4 = 1 | mod 4 = 2 | mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 2B
Applied redundancy version for PUSCH of the second TCI state

| rv_{id} indicated | | | | |
|---|---|---|---|---|
| by the | rv_{id} to be applied to n^{th} actual reptition (repetition type B) | | | |
| DCI scheduling | with second TCI state | | | |
| the PUSCH | n mod 4 = 0 | n mod 4 = 1 | n mod 4 = 2 | n mod 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

In one exemplary method, a DCI format can indicate two combinations of SRS resource(s) for port indication and uplink power control for PUSCH transmission with repetition type A or type B.

In one example, a UE can be configured with a list of M SRI-PUSCH-PowerControl. And the UE can receive one MAC CE that can map one or two SRI-PUSCH-PowerControl to one codepoint of a DCI field (for example the SRS resource indicator DCI field) of one DCI format scheduling PUSCH transmission. For a PUSCH transmission with Type A or Type repetition scheduled by a DCI format, for example DCI format 0_1 or 0_2, the DCI field (for example the SRS resource indicator DCI field) in the DCI format can indicate two SRI-PUSCH-PowerControl for the PUSCH transmission, the UE may apply those two indicated SRI-PUSCH-PowerControl on each PUSCH transmission according some predefined rule or configured pattern. For PUSCH repetition type A, the UE may apply redundancy version for PUSCH transmission occasions associated with the first SRI-PUSCH-PowerControl or the second SRI-PUSCH-PowerControl according to the methods described in this disclosure. For PUSCH repetition type B, the UE may apply redundancy version for PUSCH nominal repetitions associated with the first SRI-PUSCH-PowerControl or the second SRI-PUSCH-PowerControl according to the methods described in this disclosure. For PUSCH repetition type B, the UE may apply redundancy version for PUSCH actual repetitions associated with the first SRI-PUSCH-PowerControl or the second SRI-PUSCH-PowerControl according to the methods described in some embodiments of this disclosure.

In some embodiments, for a DCI format scheduling PUSCH transmission, for example DCI format 0_1 or 0_2 can indicate one SRS resource indicator DCI field and one SRS resource indictor-2 DCI field. The SRS resource indicator DCI field can indicate one or more SRS resources and one SRI-PUSCH-PowerControl. And the SRS resource indicator-2 DCI field can also indicate one or more SRS resources and one SRI-PUSCH-PowerControl. For a PUSCH transmission with Type A or Type repetition scheduled by a DCI format, for example DCI format 0_1 or 0_2, the UE may apply the SRS resource(s) and SRI-PUSCH-PowerControl indicated by the DCI field SRS resource indicator and the SRS resource(s) and SRI-PUSCH-PowerControl indicated by the DCI field SRS resource indicator-2 on each PUSCH transmission according some predefined rule or configured pattern. For PUSCH repetition type A, the UE may apply redundancy version for PUSCH transmission occasions associated with the SRS resource(s) and SRI-PUSCH-PowerControl indicated by the DCI field SRS resource indicator or the SRS resource(s) and SRI-PUSCH-PowerControl indicated by the DCI field SRS resource indicator-2 according to the methods described in this disclosure. For PUSCH repetition type B, the UE may apply redundancy version for PUSCH nominal repetitions associated with SRS resource(s) and SRI-PUSCH-PowerControl indicated by the DCI field SRS resource indicator and the SRS resource(s) and SRI-PUSCH-PowerControl indicated by the DCI field SRS resource indicator-2 according to the methods described in this disclosure. For PUSCH repetition type B, the UE may apply redundancy version for PUSCH actual repetitions associated with SRS resource(s) and SRI-PUSCH-PowerControl indicated by the DCI field SRS resource indicator and the SRS resource(s) and SRI-PUSCH-PowerControl indicated by the DCI field SRS resource indicator-2 according to the methods described in some embodiments of this disclosure.

According to some embodiments consistent with the present disclosure, for PUSCH repetition type B transmission, the UE can be provided with time gap (for example in terms of number of symbols) between two PUSCH repetition. The benefit for this method is the system can configure a gap between two adjacent PUSCH repetition so that the UE is able to switch the Tx beams applied on two adjacent PUSCH repetitions. In an exemplary method, for PUSCH repetition type B transmission, the UE is provided with a higher layer parameter that provides the information of number of symbols between two adjacent nominal repetitions.

In a first example, the UE can be configured with a higher layer parameter PuschStartingSymbolOffsetK with a value K̅. For PUSCH repetition Type B transmisison, the number of nominal repetitions is given by numberofrepetitions. For the n-th nominal repetition, n=0, . . . , numberofrepetitions−1, wherein the slot where the nominal repetition starts is given by

$${K}_{s} + ⌊ \frac{S + n \cdot L + n \overline{K}}{{N}_{s y m b}^{s l o t}} ⌋ ,$$

and the starting symbol relative to the start of the slot is given by mod(S+n·(L+n·K̅, N_{symb}^{slot}). The slot where the nominal repetition ends is given by

$${K}_{s} + ⌊ \frac{S + ( n + 1 ) \cdot ( L + \overline{K} ) - 1}{{N}_{s y m b}^{s l o t}} ⌋ ,$$

and the ending symbol relative to the start of the slot is given by mod(S+(n+1)·(L+K̅)−1, N_{symb}^{slot}). Here Kₛ is the slot where the PUSCH transmission starts, and N_{symb}^{slot} is the number of symbols per slot. When the higher layer parameter PuschStartingSymbolOffsetK is not configured, the UE can assume K̅=0.

In a second example, the UE can be configured with a higher layer parameter PuschStartingSymbolOffsetK with a value K̅ that specifies the number of symbols between two adjacent PUSCH nominal repetitions. The UE can be requested to apply the value of K̅ only between two adjacent nominal repetitions that are associated with different UL TCI states. For two adjacent nominal repetitions that are associated with same UL TCI states, the UE can assume the value of K̅ is zero. In an exemplary method, for PUSCH repetition type B transmission, the UE is provided with a higher layer parameter that provides the information of number of symbols between two adjacent actual repetitions.

In one example, for PUSCH repetition type B transmission, the UE may first determine the slot and symbol location for each nominal repetition. Then the UE determines invalid symbols(s) for PUSCH repetition type B transmission. For PUSCH repetition type B transmission, after determining the invalid symbol(s) for PUSCH repetition type B transmission for each of the K nominal repetitions, the remaining symbols are considered as potentially valid symbols for PUSCH repetition Type B transmission. Then the UE can determine the PUSCH actual repetitions. The UE can be configured with a higher layer parameter PuschStartingSymbolOffsetK with a value K̅. If the number of symbols, L₀, between the first symbol of n-th actual repetition and the last symbol of (n−1)-th actual repetition is less than the value of K̅, the UE may assume the first K̅−L₀ symbols in the n-th actual repetition are invalid. Otherwise, the UE use the determined actual repetition.

In a second example, the UE can be configured with a higher layer parameter PuschStartingSymbolOffsetK with a value K̅ that specifies the number of symbols between two adjacent PUSCH actual repetitions. The UE can be requested to apply the value of K̅ only between two adjacent actual repetitions that are associated with different UL TCI states. For two adjacent actual repetitions that are associated with same UL TCI state, the UE can assume the value of K̅ is zero.

In summary, some embodiments of the present disclosure provide the following methods for transmitting PUSCH with repetition in multi-TRP system:

The UE is configured with M TCI state for PUSCH transmission and each TCI state include the information of SRS resource(s) for port indication, spatial relation configuration and/or uplink power control parameters. The gNB can map one or two TCI states to one codepoint of a first DCI field in the DCI format 0_1 or 0_2. For a PUSCH with repetition Type A or Type B, the UE apply the indicted TCI states on each PUSCH transmission occasion. For PUSCH with repetition Type A, the UE applies redundancy version on PUSCH transmission occasions associated with the first UL TCI states and with the second UL TCI states respectively. For PUSCH with repetition Type B, the UE applies redundancy version on PUSCH nominal repetitions associated with the first UL TCI states and with the second UL TCI states respectively. For PUSCH with repetition Type B, the UE applies redundancy version on PUSCH actual repetitions associated with the first UL TCI states and with the second UL TCI states respectively.

For PUSCH with repetition type B, the UE can be provided with a higher layer parameter that provides a number of symbols between two PUSCH transmissions: Example 1: the UE may apply the gap of symbols on nominal repetitions and the UE may include the number of symbols for the time gap in determining the symbol and slot locations for each nominal repetition. Example 2: the UE may apply the gap of symbols on actual repetitions. Example 3: the UE only applies the configured gap of symbols between two adjacent nominal repetitions when these two nominal repetitions are associated with different UL TCI states. Example 4: the UE only applies the configured gap of symbols between two adjacent actual repetitions when these two actual repetitions are associated with different UL TCI states.

The following 3GPP standards are incorporated in some embodiments of this disclosure by reference in their entireties: 3GPP TS 38.211 V15.5.0: “NR; Physical channels and modulation”, 3GPP TS 38.212 V15.5.0: “NR; Multiplexing and channel coding”, 3GPP TS 38.213 V15.5.0: “NR; Physical layer procedures for control”, 3GPP TS 38.214 V15.5.0: “NR; Physical layer procedures for data”, 3GPP TS 38.215 V15.5.0: “NR; Physical layer measurements”, 3GPP TS 38.321 V15.5.0: “NR; Medium Access Control (MAC) protocol specification”, and/or 3GPP TS 38.331 V15.5.0: “NR; Radio Resource Control (RRC) protocol specification”.

The following table includes some abbreviations, which may be used in some embodiments of the present disclosure:

| | |
|---|---|
| 3GPP | 3^{rd} Generation Partnership Project |
| 5G | 5^{th} Generation |
| NR | New Radio |
| gNB | Next generation NodeB |
| DL | Downlink |
| UL | Uplink |
| PUSCH | Physical Uplink Shared Channel |
| PUCCH | Physical Uplink Control Channel |
| PDSCH | Physical Downlink Shared Channel |
| PDCCH | Physical Downlink Control |
| | Channel |
| SRS | Sounding Reference Signal |
| CSI | Channel state information |
| CSI-RS | Channel state information reference |
| | signal |
| RS | Reference Signal |
| CORESET | Control Resource Set |
| DCI | Downlink control information |
| TRP | Transmission/reception point |
| ACK | Acknowledge |
| NACK | Non-Acknowledge |
| UCI | Uplink control information |
| RRC | Radio Resource Control |
| HARQ | Hybrid Automatic Repeat Request |
| MAC | Media Access Control |
| MAC CE | Media Access Control Control |
| | Element |
| CRC | Cyclic Redundancy Check |
| RNTI | Radio Network Temporary Identity |
| RB | Resource Block |
| PRB | Physical Resource Block |
| NW | Network |
| RSRP | Reference signal received power |
| L1-RSRP | Layer 1 Reference signal received |
| | power |
| TCI | Transmission Configuration |
| | Indicator |
| Tx | Transmission |
| Rx | Receive |
| QCL | Quasi co-location |
| SSB | SS/PBCH Block |
| PT-RS | Phase Tracking Reference Signal |

Commercial interests for some embodiments are as follows. 1. Solving issues in the prior art. 2. Utilizing multi-transmission/reception point (TRP) reception. 3. Improving uplink reliability. 4. Providing a good communication performance. 5. Providing high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. The deployment scenarios include, but not limited to, indoor hotspot, dense urban, urban micro, urban macro, rural, factor hall, and indoor D2D scenarios. Some embodiments of the present disclosure are a combination of “techniques/processes” that can be adopted in 3GPP specification to create an end product. Some embodiments of the present disclosure could be adopted in 5G NR licensed and non-licensed or shared spectrum communications. Some embodiments of the present disclosure propose technical mechanisms. The present example embodiment is applicable to NR in unlicensed spectrum (NR-U). The present disclosure can be applied to other mobile networks, in particular to mobile network of any further generation cellular network technology (6G, etc.).

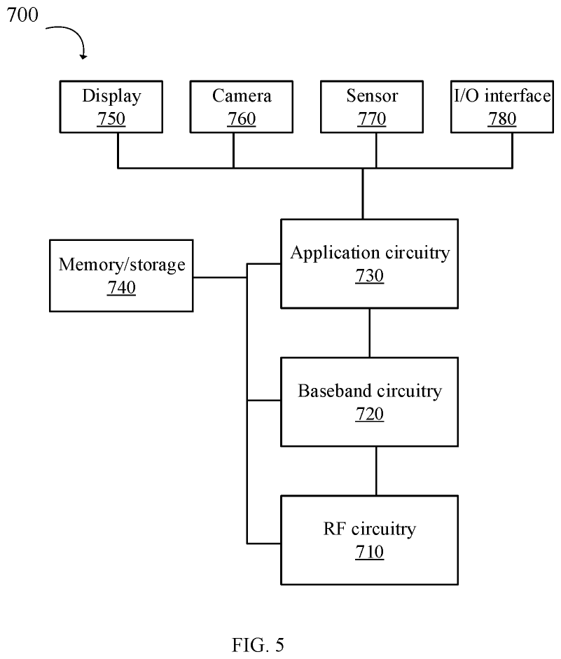

FIG. 5 is a block diagram of an example system 700 for wireless communication according to an embodiment of the present disclosure. Embodiments described herein may be implemented into the system using any suitably configured hardware and/or software. FIG. 5 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method by a user equipment (UE), comprising:
being scheduled with a physical uplink shared channel (PUSCH) with one or more repetition transmissions; and
being indicated with transmission configurations for the PUSCH with one or more repetition transmissions, wherein for the PUSCH with one or more repetition transmissions, an indicated transmission configuration is applied on each PUSCH transmission occasion, and a redundancy version is applied on at least one PUSCH transmission occasion associated with the transmission configurations.

2. The method of claim 1, wherein the UE is requested to apply an indicated transmission configuration on one or more PUSCH repetition transmissions.

3. The method of claim 1, wherein the PUSCH with one or more repetition transmissions comprise a PUSCH type A repetition and a PUSCH type B repetition, and the TCI states comprises a first TCI state and a second TCI state.

4. The method of claim 3, wherein for the PUSCH type A repetition, an indicated transmission configuration is applied on each PUSCH transmission; wherein for the PUSCH type B repetition, an indicated transmission configuration is applied on each PUSCH nominal repetition or each PUSCH actual repetition; for the PUSCH type A repetition, the redundancy version is applied on PUSCH transmission occasions associated with the first TCI state and the second TCI state respectively; and/or for the PUSCH type B repetition, the redundancy version is applied on PUSCH nominal repetitions or PUSCH actual repetitions associated with the first TCI state and the second TCI state respectively.

5. The method of claim 3, wherein the UE is scheduled with the PUSCH with one or more repetition transmissions through downlink control information (DCI).

6. The method of claim 5, wherein the DCI comprises a DCI format 0_1 or a DCI format 0_2.

7. The method of claim 5, wherein one or more TCI states or one or more higher layer parameters are mapped to one or more codepoints of a DCI field in the DCI; wherein the DCI indicates a first SRI DCI field and a second SRI DCI field, the first SRI DCI field indicates one or more SRS resources and one SRI-PUSCH-PowerControl parameter, and/or the second SRI DCI field indicates one or more SRS resources and one SRI-PUSCH-PowerControl parameter; and/or wherein a mapping pattern of applying an indicated transmission configuration is performed on each PUSCH transmission occasion.

8. A user equipment (UE), comprising:
a memory;
a transceiver; and
a processor coupled to the memory and the transceiver;
wherein the processor is configured to be scheduled with a physical uplink shared channel (PUSCH) with one or more repetition transmissions; and
wherein the processor is configured to be indicated with transmission configurations for the PUSCH with one or more repetition transmissions, wherein for the PUSCH with one or more repetition transmissions, an indicated transmission configuration is applied on each PUSCH transmission occasion, and a redundancy version is applied on at least one PUSCH transmission occasion associated with the transmission configurations.

9. The UE of claim 8, wherein the processor is requested to apply an indicated transmission configuration on one or more PUSCH repetition transmissions; and/or wherein the PUSCH with one or more repetition transmissions comprise a PUSCH type A repetition and a PUSCH type B repetition, and the TCI states comprises a first TCI state and a second TCI state.

10. The UE of claim 9, wherein for the PUSCH type A repetition, an indicated transmission configuration is applied on each PUSCH transmission; wherein for the PUSCH type B repetition, an indicated transmission configuration is applied on each PUSCH nominal repetition or each PUSCH actual repetition; wherein for the PUSCH type A repetition, the redundancy version is applied on PUSCH transmission occasions associated with the first TCI state and the second TCI state respectively; wherein for the PUSCH type B repetition, the redundancy version is applied on PUSCH nominal repetitions or PUSCH actual repetitions associated with the first TCI state and the second TCI state respectively; and/or the processor is scheduled with the PUSCH with one or more repetition transmissions through downlink control information (DCI).

11. The UE of claim 10, wherein the DCI comprises a DCI format 0_1 or a DCI format 0_2; wherein one or more TCI states or one or more higher layer parameters are mapped to one or more codepoints of a DCI field in the DCI; wherein the DCI indicates a first SRI DCI field and a second SRI DCI field, the first SRI DCI field indicates one or more SRS resources and one SRI-PUSCH-PowerControl parameter, and/or the second SRI DCI field indicates one or more SRS resources and one SRI-PUSCH-PowerControl parameter; and/or wherein a mapping pattern of applying an indicated transmission configuration is performed on each PUSCH transmission occasion.

12. A base station, comprising:
a memory;
a transceiver; and
a processor coupled to the memory and the transceiver;
wherein the processor is configured to schedule, to a user equipment (UE), a physical uplink shared channel (PUSCH) with one or more repetition transmissions; and
wherein the processor is configured to indicate, to the UE, transmission configurations for the PUSCH with one or more repetition transmissions, wherein for the PUSCH with one or more repetition transmissions, an indicated transmission configuration is applied on each PUSCH transmission occasion, and a redundancy version is applied on at least one PUSCH transmission occasion associated with the transmission configurations.

13. The base station of claim 12, wherein the processor is configured to request the UE to apply an indicated transmission configuration on one or more PUSCH repetition transmissions.

14. The method of claim 12, wherein the PUSCH with one or more repetition transmissions comprise a PUSCH type A repetition and a PUSCH type B repetition, and the TCI states comprises a first TCI state and a second TCI state.

15. The base station of claim 14, wherein for the PUSCH type A repetition, an indicated transmission configuration is applied on each PUSCH transmission; wherein for the PUSCH type B repetition, an indicated transmission configuration is applied on each PUSCH nominal repetition or each PUSCH actual repetition; for the PUSCH type A repetition, the redundancy version is applied on PUSCH transmission occasions associated with the first TCI state and the second TCI state respectively; and/or wherein for the PUSCH type B repetition, the redundancy version is applied on PUSCH nominal repetitions or PUSCH actual repetitions associated with the first TCI state and the second TCI state respectively.

16. The base station of claim 14, wherein the UE is scheduled with the PUSCH with one or more repetition transmissions through downlink control information (DCI).

17. The base station of claim 16, wherein the DCI comprises a DCI format 0_1 or a DCI format 0_2.

18. The base station of claim 16, wherein one or more TCI states or one or more higher layer parameters are mapped to one or more codepoints of a DCI field in the DCI.

19. The base station of claim 16, wherein the DCI indicates a first SRI DCI field and a second SRI DCI field, the first SRI DCI field indicates one or more SRS resources and one SRI-PUSCH-PowerControl parameter, and/or the second SRI DCI field indicates one or more SRS resources and one SRI-PUSCH-PowerControl parameter.

20. The base station of claim 16, wherein a mapping pattern of applying an indicated transmission configuration is performed on each PUSCH transmission occasion.
